(19) United States
(12) Patent Application Publication
(10) Pub. No.: US 2026/0055033 A1
(43) Pub. Date: Feb. 26, 2026

(54) DIELECTRIC SLURRY COMPOSITION AND DIELECTRIC CERAMIC SHEET USING SAME

(71) Applicant: SAMSUNG ELECTRO-MECHANICS CO., LTD., Suwon-si (KR)

(72) Inventors: Young-O KIM, Suwon-si (KR); Jung Jin PARK, Suwon-si (KR); Rak Hyeon BAEK, Suwon-si (KR); Ho Sam CHOI, Suwon-si (KR); Dong Jun JUNG, Suwon-si (KR); Jong Ho LEE, Suwon-si (KR)

(73) Assignee: SAMSUNG ELECTRO-MECHANICS CO., LTD., Suwon-si (KR)

(21) Appl. No.: 19/252,309

(22) Filed: Jun. 27, 2025

(30) Foreign Application Priority Data
Aug. 20, 2024 (KR) 10-2024-0111254
Dec. 27, 2024 (KR) 10-2024-0199167

(51) Int. Cl. C04B 35/634; C04B 35/468; C04B 35/628; H01G 4/12; H01G 4/30

(52) U.S. Cl. CPC C04B 35/63444; C04B 35/4682; C04B 35/628; C04B 35/6342; C04B 2235/3236; H01G 4/1227; H01G 4/30

(57) ABSTRACT

A dielectric slurry composition includes a dielectric particle including BaTiO₃, a solvent including ethanol and toluene, a dispersant including polyvinylpyrrolidone, and a binder, wherein a mass ratio of ethanol to toluene is greater than 1.0 and less than 2.3. A molecular weight of polyvinylpyrrolidone may be 6300 g/mol or more and 309000 g/mol or less.

### CROSS-REFERENCE TO RELATED APPLICATION(S)

This application claims benefit of priority to Korean Patent Application Nos. 10-2024-0111254 filed on Aug. 20, 2024 and 10-2024-0199167 filed on Dec. 27, 2024 in the Korean Intellectual Property Office, the disclosure of which is incorporated herein by reference in its entirety.

### TECHNICAL FIELD

The present disclosure relates to a dielectric slurry composition and a dielectric ceramic sheet using the same.

A multilayer ceramic capacitor (MLCC), a multilayer electronic component, is a chip-type condenser mounted on the printed circuit boards of various electronic products, such as image display devices including liquid crystal displays (LCDs) and plasma display panels (PDPs), computers, smartphones, cellular phones, on-board chargers (OBCs), DC-DC converters, and the like, to allow electricity to be charged therein and discharged therefrom.

In order to miniaturize and increase the capacity of a multilayer ceramic capacitor, it is necessary to increase the number of layers by thinning dielectric ceramic sheets forming a dielectric layer. In this case, the influence of a thickness deviation, roughness dispersion, and stiffness of the dielectric ceramic sheets on electrical characteristics of the multilayer ceramic capacitor may increase, as compared to a case in which dielectric sheets are formed to be thick. Therefore, in order to miniaturize and increase the capacity of the multilayer ceramic capacitor, it may be important to secure the dispersion of the dielectric slurry composition forming the dielectric layer and the strength and chemical resistance of the dielectric ceramic sheet.

In order to secure the homogeneity of the dielectric slurry composition, a method of improving dispersion stability by adding a dispersant at a weighing stage may be used, and in the related art, there have been attempts to use polyvinyl butyral as a dispersant.

However, since a functional group that may act as a hydrogen bond donor in the dispersant of the related art is less than about 40 mol % in the entire polymer, there may be limitations in improving interfacial bonding force between a binder and dielectric particles and mechanical strength of the dielectric ceramic sheet.

Therefore, there is a need for a method to form a dielectric slurry composition with enhanced steric hindrance effect between dispersants and the dispersion stability of the dielectric particles by increasing the number of hydrogen bonds between the binder and the dielectric particles or controlling the molecular weight of the dispersant and to improve the mechanical properties of the dielectric ceramic sheet by using the same.

### SUMMARY

An aspect of the present disclosure is to provide a dielectric slurry composition having improved dispersibility of dielectric particles.

Another aspect of the present disclosure is to improve mechanical strength of a dielectric ceramic sheet.

However, the purpose of the present disclosure is not limited to the aforementioned contents and will be more easily understood in the process of describing specific embodiments of the present disclosure.

According to an aspect of the present disclosure, a dielectric slurry composition includes: a dielectric particle including BaTiO₃, a solvent including ethanol and toluene, a dispersant including polyvinylpyrrolidone, and a binder, wherein a mass ratio of ethanol to toluene is greater than 1.0 and less than 2.3.

According to another aspect of the present disclosure, a dielectric ceramic sheet includes: a dielectric particle including BaTiO₃, a dispersant including polyvinylpyrrolidone, a binder, and a plasticizer, wherein the plasticizer has a negative charge.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 is a perspective view schematically illustrating a multilayer electronic component according to an embodiment of the present disclosure;

FIG. 2 is a cross-sectional view taken along line I-I′ of FIG. 1;

FIG. 3 illustrates a structural formula of polyvinyl butyral (PVB);

FIG. 4 illustrates a structural formula of polyvinylpyrrolidone (PVP);

FIGS. 5A to 5C illustrate states of BaTiO₃ particles in a dielectric slurry according to the molecular weight of a PVP dispersant;

FIG. 6 is a graph analyzing samples of dielectric slurry compositions with different types of dispersants using Fourier transform infrared spectroscopy;

FIG. 7 is a graph comparing dispersion stability and viscosity of samples of dielectric slurry compositions with PVB as a dispersant and samples of dielectric slurry compositions with PVP dispersants with different molecular weights;

FIG. 8 is a graph comparing a particle size distribution of samples of dielectric slurry compositions with PVB as a dispersant and samples of dielectric slurry compositions with PVP dispersants with different molecular weights;

FIG. 9 is a graph analyzing samples of dielectric slurry compositions with PVB as a binder and samples of dielectric slurry compositions with PVB binders and PVP dispersants with different molecular weights using Fourier transform infrared spectroscopy;

FIG. 10 is a graph illustrating stress-strain curves of samples of dielectric ceramic sheets with different types of dispersants; and

FIG. 11A is a graph illustrating short rates of multilayer electronic components including dielectric layers with different types of dispersants, and FIG. 11B is a graph illustrating breakdown voltage (BDV) distributions of multilayer electronic components including dielectric layers with different types of dispersants.

### DETAILED DESCRIPTION

Hereinafter, exemplary embodiments of the present inventive concept will be described in detail with reference to the accompanying drawings. The inventive concept may, however, be exemplified in many different forms and should not be construed as being limited to the specific embodiments set forth herein. Rather, these embodiments are provided so that this disclosure will be thorough and complete, and will fully convey the scope of the inventive concept to those skilled in the art. In the drawings, the shapes and dimensions of elements may be exaggerated for clarity, and the same reference numerals will be used throughout to designate the same or like elements.

To clarify the present disclosure, portions irrespective of description are omitted and like numbers refer to like elements throughout the specification, and in the drawings, the thickness of layers, films, panels, regions, etc., are exaggerated for clarity. Also, in the drawings, like reference numerals refer to like elements although they are illustrated in different drawings. Throughout the specification, unless explicitly described to the contrary, the word “comprise” and variations, such as “comprises” or “comprising,” will be understood to imply the inclusion of stated elements but not the exclusion of any other elements.

In the drawings, a first direction may be defined as a direction in which first and second internal electrodes are alternately arranged with a dielectric layer therebetween or a thickness (T) direction, and among second direction and third direction, which are directions, perpendicular to the first direction, the second direction may be defined as a length (L) direction and the third direction may be defined as a width (W) direction.

### Dielectric Slurry Composition

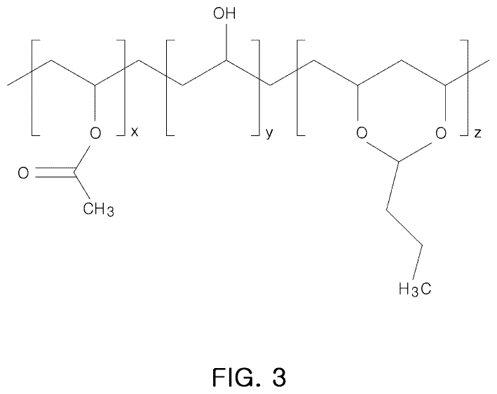

FIG. 3 illustrates a structural formula of polyvinyl butyral (PVB).

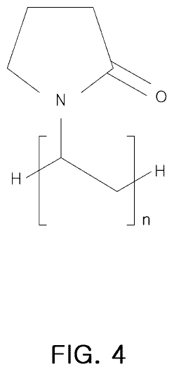

FIG. 4 illustrates a structural formula of polyvinylpyrrolidone (PVP).

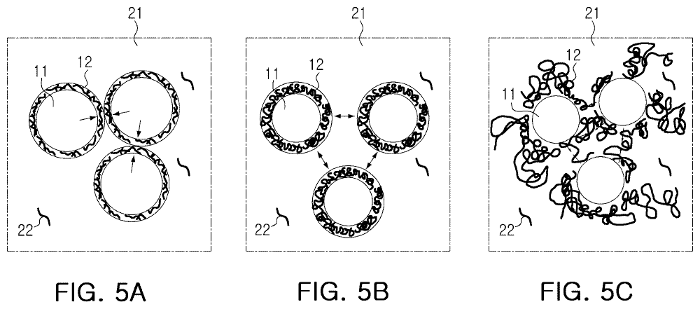

FIG. 5 illustrates a state of BaTiO₃ particles in a dielectric slurry according to a molecular weight of a PVP dispersant.

Hereinafter, a dielectric slurry composition according to an embodiment of the present disclosure and various examples thereof will be described in detail with reference to FIGS. 3 to 5.

A dielectric slurry composition according to an embodiment of the present disclosure may include dielectric particles 11 including BaTiO₃, a solvent 21 including ethanol and toluene, a dispersant 12 including polyvinylpyrrolidone, and a binder 22.

The dielectric particles 11 may include BaTiO₃ and may be a main component of a dielectric layer of a multilayer electronic component. The dielectric particles 11 may further include not only BaTiO₃, but also (Ba₁₋ₓCaₓ)TiO₃ (0<x<1), Ba(Ti_{1-y}Ca_{y})O₃ (0<y<1), (Ba₁₋ₓCaₓ)(Ti_{1-y}Zr_{y})O₃ (0<x<1, 0<y<1) or Ba(Ti_{1-y}Zr_{y})O₃ (0<y<1) in which Ca (calcium), Zr (zirconium), or the like is partially dissolved in BaTiO₃.

The dielectric particles 11 included in the dielectric slurry composition need to be evenly and stably dispersed in a dielectric slurry composition and need to sufficiently form interactions with other components in the dielectric slurry composition to form a dielectric ceramic sheet. Accordingly, the dielectric slurry composition may include a ceramic additive, a solvent 21, a dispersant 12, a binder 22, etc.

Referring to FIG. 4, polyvinylpyrrolidone has a functional group acting as a hydrogen bond acceptor for each monomer and thus is a dispersant with excellent miscibility with a dielectric particle surface including BaTiO₃, the binder, and the solvent used in the slurry preparation.

Meanwhile, referring to FIG. 3, the conventional dispersant including polyvinyl butyral (PVB) has a repeating unit containing carbonyl group (C═O) and a repeating unit containing a hydroxyl group (—OH) serving as hydrogen bond acceptors, whereas, referring to FIG. 4, all functional groups in a polymer chain of polyvinylpyrrolidone may form hydrogen bonds. The characters “x”, “y”, and “z” in FIG. 4 refer to the number of each repeating unit.

Therefore, in the case that the dielectric slurry composition includes a dispersant including polyvinylpyrrolidone as in an embodiment of the present disclosure, interfacial adhesive strength between the binder and the dielectric particles may be increased, and as a result, mechanical strength, such as strength of a dielectric ceramic sheet may be improved.

The dispersant including polyvinylpyrrolidone has excellent miscibility with an ethanol rich solvent. Accordingly, in an embodiment of the present disclosure, in the solvent 21 including ethanol and toluene, the mass ratio of ethanol to toluene may exceed 1.0.

Meanwhile, in the case that the mass ratio of ethanol to toluene is 2.3 or more, a proportion of toluene, which is a non-polar solvent, in the entire solvent is excessive, so that dielectric particles may precipitate. Therefore, in an embodiment of the present disclosure, the mass ratio of ethanol to toluene may be less than 2.3.

In an example of a method for measuring the mass ratio of ethanol to toluene in the dielectric slurry composition, the dielectric slurry composition may be filtered to obtain only a solvent, and then the toluene and ethanol contents in the solvent may be analyzed through gas chromatography-mass spectrometry (GC-MS), and the mass ratio may be calculated therethrough.

In an embodiment, the dispersant 12 including polyvinylpyrrolidone may be disposed on a surface of the dielectric particle 11, and whether the dispersant 12 including polyvinylpyrrolidone is disposed on the surface of the dielectric particle 11 may be confirmed by detecting nitrogen (N) elements on the surface of the dispersant through transmission electron microscopy-energy dispersive X-ray spectroscopy (TEM-EDS) analysis or Fourier transform-infrared spectroscopy (FT-IR) analysis.

In the case that the dispersant 12 including polyvinylpyrrolidone is disposed on the surface of the dielectric particle 11, the dielectric particles 11 may be evenly dispersed in the ethanol-toluene solvent 21.

In the dielectric slurry composition, a molecular weight of the dispersant 12 including polyvinylpyrrolidone may be another factor affecting dispersibility of the dielectric particles. In the case that the molecular weight of the dispersant 12 including polyvinylpyrrolidone is less than 6300 g/mol, a repulsive force sufficient to overcome attractive force between the dielectric particles 11 may not be formed, and thus the dielectric particles 11 may exist in an aggregated state in the solvent, as shown in FIG. 5A. In the case that the molecular weight of the dispersant 12 including polyvinylpyrrolidone exceeds 309000 g/mol, dispersant chains extending from the surface of the dielectric particle 11 into the solvent may become entangled with dispersant chains formed on the surface of adjacent dielectric particles, and thus the dielectric particles 11 may exist in an agglomerated form as shown in FIG. 5C. In an embodiment, by controlling the molecular weight of the dispersant 12 including polyvinylpyrrolidone to 6300 g/mol or more and 309000 g/mol or less, the dielectric particles may be evenly dispersed in the solvent as shown in FIG. 5B.

The molecular weight of the dispersant 12 including polyvinylpyrrolidone may be measured through gel permeable chromatography (GPC) and may be measured under the conditions of Column: PL Aquagel-OH mixed×2 (300×7.5 mm)/40° C., Flow rate: 0.8 ml/min, Mobile phase solvent: DI water with buffer (0.2 M NaNO₃+0.01 M Na₂HPO₄), 30% MeOH, Injection volume: 100 ul, but the present disclosure is not limited thereto.

In an embodiment, the Hansen Solubility Parameter Ra of the dispersant 12 included in the dielectric slurry composition may be greater than 13 and less than 16. If the solubility parameter Ra is 13 or less, the dispersant 12 may have a relatively greater tendency to be dissolved in the solvent than to be disposed on the surface of the dielectric particles 11, which may result in that interfacial force between the dielectric particles 11 and the binder 22 is not sufficiently increased. In addition, in the case that the Hansen Solubility Parameter Ra of the dispersant including PVP is 16 or more, the binder may clump in the case that the dispersant is mixed with the binder. Meanwhile, in the case that the solubility parameter of the dispersant 12 in the ethanol-toluene solvent 21 exceeds 13 and is less than 16 as in an embodiment, the dispersant 12 has a greater tendency to be disposed on the surface of the dielectric particle 11 than to be dissolved in the solvent 21, so that the interfacial force between the dielectric particle 11 and the binder 22 may be sufficiently increased and the aggregation or precipitation of the dielectric particle 11 may be prevented, thereby improving the dispersibility of the dielectric slurry composition.

Meanwhile, the Hansen Solubility Parameter value is a value used to predict solubility of a substance, and HSP for a wide range of solvents are known, and the solubility of organic substances in a series of HSP solvents may be measured as affinity. The best fit may be analyzed and calculated from solubility test results using a program called Hansen Solubility Parameters in Practice (HSPiP) developed by the Dr. Hansen group, and the Ra value may be controlled by adjusting the ratio of the ethanol and toluene contents of the solvent. Other methods and/or tools appreciated by one of ordinary skill in the art, even if not described in the present disclosure, may also be used.

In an embodiment, the binder 22 of the dielectric composition may include polyvinyl butyral.

The polyvinylpyrrolidone dispersant 12 has one carbonyl group (C═O), which is a hydrogen bond acceptor group, in addition to the hydrophobic interaction per monomer, and forms a hydrogen bond with the hydroxyl group (—OH), which is a hydrogen bond donor group of the polyvinyl butyral (PVB) binder 22. Meanwhile, in the case that both the dispersant and the binder include polyvinyl butyral, complex interactions may occur because both hydrogen bond acceptors and donors are included.

Therefore, in the case that the dispersant 12 of the dielectric slurry composition includes polyvinylpyrrolidone and the binder 22 includes polyvinyl butyral as in an embodiment, the interaction between the dispersant 12 and the binder 22 on the surface of the dielectric particle 11 may increase. Accordingly, the dispersion stability may be improved compared to the case in which both the dispersant and the binder include polyvinyl butyral.

Meanwhile, in the case that the dielectric composition includes polyvinylpyrrolidone as a dispersant 12 and polyvinyl butyral as a binder 22, if the number of monomers or repeating units of polyvinylpyrrolidone is n, and the number of monomers or repeating units that include hydroxyl groups included in polyvinyl butyral (PVB) is y, n/y may satisfy 0.67 or more and less than 3.7. Accordingly, the interaction between the dispersant and the binder may be improved. Meanwhile, if n/y is 3.7 or more, the agglomeration of dielectric particles may become severe and it may be difficult to control the properties of the dielectric sheet. Meanwhile, the n/y value may be adjusted together with a C value in the case that the molar ratio of the PVP dispersant and the PVB binder is multiplied by the number of PVP monomers multiplied by the number of hydroxyl group monomers of the PVB binder is C. Specifically, in the case that an average size of the dielectric particles is 70 nm, the C value may be 8.5 or more, and in the case that the average size of the dielectric particles is 100 nm, the C value may be 5.7 or more.

### Dielectric Ceramic Sheet

The dielectric slurry composition according to an embodiment of the present disclosure and the dielectric slurry composition according to various embodiments thereof may be manufactured into a dielectric ceramic sheet through an additional process.

The method of manufacturing the dielectric slurry composition into a dielectric ceramic sheet is not particularly limited, and after a binder and a plasticizer are added to a dielectric slurry composition, a corresponding mixture may be applied to a polyethylene terephthalate (PET) film by a doctor blade method, and a drying operation may be performed to remove the solvent inside the dielectric slurry composition.

The dielectric ceramic sheet according to an embodiment of the present disclosure may include substantially the same components as the dielectric slurry composition according to an embodiment and various embodiments of the present disclosure, except for the solvent and the binder.

Specifically, the dielectric ceramic sheet may include dielectric particles including BaTiO₃, a dispersant including polyvinylpyrrolidone, a binder, and a plasticizer. Since the dielectric ceramic sheet includes polyvinylpyrrolidone as a dispersant, the mechanical properties of the dielectric ceramic sheet may be improved.

Meanwhile, the dielectric ceramic sheet including polyvinylpyrrolidone as a dispersant may include a plasticizer, and in the case that the plasticizer has a negative charge, the absolute size of static electricity occurring during peeling may be reduced, thereby reducing defects occurring during stacking of the dielectric ceramic sheet. In the case that the plasticizer has a negative charge, the effect of reducing static electricity occurring during peeling may be better in the case that polyvinylpyrrolidone is included as a dispersant than in the case that polyvinyl butyral is included as a dispersant. Therefore, in the case that forming a dielectric layer of a multilayer electronic component with a dielectric ceramic sheet including dielectric particles including BaTiO₃, a dispersant including polyvinylpyrrolidone, a binder, and a negatively charged plasticizer as in an embodiment of the present disclosure, a short ratio may be reduced, a breakdown voltage (BDV) distribution may be improved, that is, the electrical characteristics of the multilayer electronic component may be improved.

Meanwhile, examples of negatively charged plasticizers include plasticizers, such as triglyme, tetraglyme, and polyglyme. That is, in an embodiment, the plasticizer may include one or more of triglyme, tetraglyme, and polyglyme.

In an embodiment, by controlling the molecular weight of the dispersant including polyvinylpyrrolidone to be 6300 g/mol or more and 309000 g/mol or less, the dielectric particles may be evenly dispersed in the dielectric slurry composition, and thus the mechanical properties of the dielectric ceramic sheet may be improved.

In an embodiment, the binder of the dielectric ceramic sheet may include polyvinyl butyral. Accordingly, the interaction between the dispersant and the binder on the surface of the dielectric particles may be increased, and the mechanical properties of the dielectric ceramic sheet may be improved compared to in the case that both the dispersant and the binder include polyvinyl butyral.

In an embodiment, in the case that the dielectric ceramic sheet includes polyvinylpyrrolidone as a dispersant and polyvinyl butyral as a binder, if the number of monomers or repeating units in polyvinylpyrrolidone is n and the number of monomers or repeating units including hydroxyl groups included in polyvinyl butyral (PVB) is y, n/y may satisfy 0.67 or more and less than 3.7. Accordingly, the interaction between the dispersant and the binder may be improved, so that the mechanical properties of the dielectric ceramic sheet may be improved. If n/y is 3.7 or more, the agglomeration of dielectric particles may become severe and it may be difficult to control the properties of the dielectric sheet. Meanwhile, the n/y value may be adjusted together with a C value in the case that the molar ratio of the PVP dispersant and the PVB binder is multiplied by the number of PVP monomers multiplied by the number of hydroxyl group monomers of the PVB binder is C. Specifically, in the case that an average size of the dielectric particles is 70 nm, the C value may be 8.5 or more, and in the case that the average size of the dielectric particles is 100 nm, the C value may be 5.7 or more.

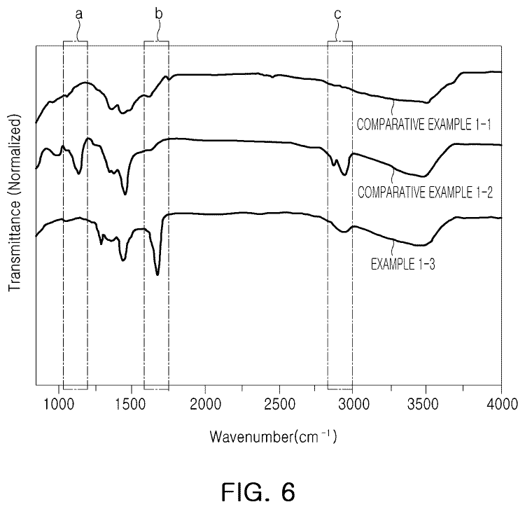

FIG. 6 is a graph analyzing samples of dielectric slurry compositions with different types of dispersants using Fourier transform infrared spectroscopy.

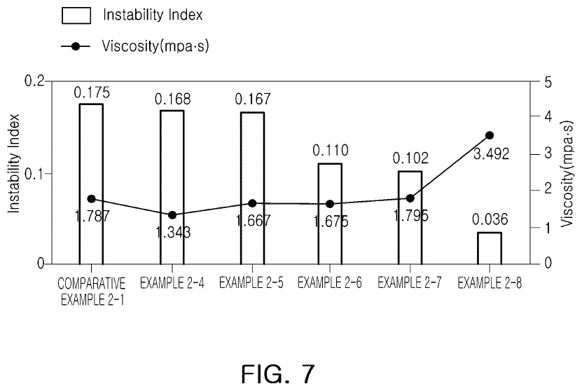

FIG. 7 is a graph comparing dispersion stability and viscosity of samples of dielectric slurry compositions with PVB as a dispersant and samples of dielectric slurry compositions with PVP dispersants with different molecular weights.

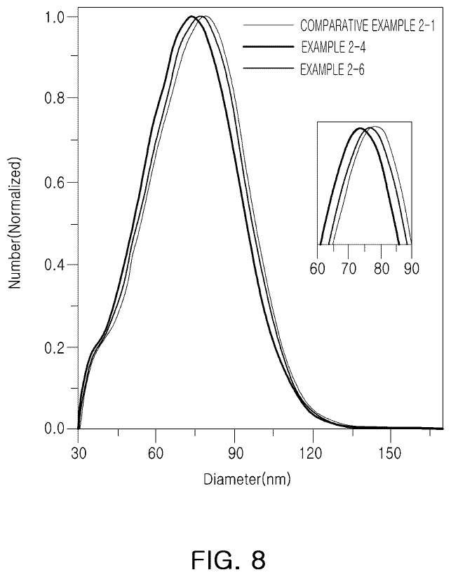

FIG. 8 is a graph comparing a particle size distribution of samples of dielectric slurry compositions with PVB as a dispersant and samples of dielectric slurry compositions with PVP dispersants with different molecular weights.

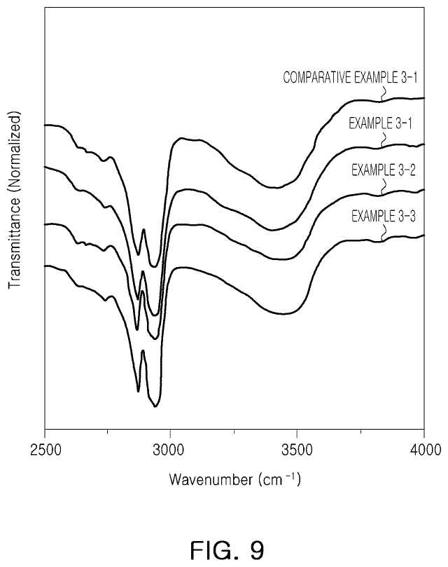

FIG. 9 is a graph analyzing samples of dielectric slurry compositions with PVB as a binder and samples of dielectric slurry compositions with PVB binders and PVP dispersants with different molecular weights using Fourier transform infrared spectroscopy.

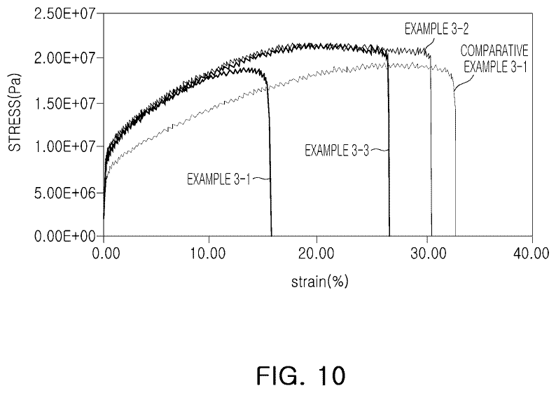

FIG. 10 is a graph illustrating stress-strain curves of samples of dielectric ceramic sheets with different types of dispersants.

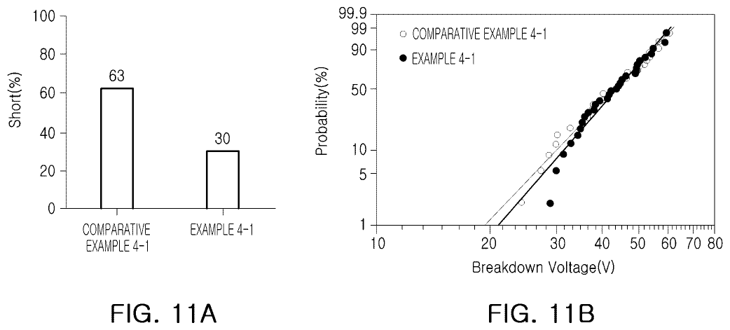

FIG. 11A is a graph illustrating short rates of multilayer electronic components including dielectric layers with different types of dispersants, and FIG. 11B is a graph illustrating breakdown voltage (BDV) distributions of multilayer electronic components including dielectric layers with different types of dispersants.

Hereinafter, an experimental example of a dielectric slurry composition and a dielectric ceramic sheet according to an embodiment will be described in detail with reference to FIGS. 6 to 11.

In each experimental example, a dielectric slurry composition sample was formed by introducing a PVP or PVB dispersant solution (10 wt % in ethanol), BaTiO₃ (70 nm) powder, and zirconia beads in an EtOH/Tol mixed solvent in a vial and milling the same. Before the milling process was completed, a PVB resin was dissolved in a mixture of ethanol and toluene by ultrasonic treatment until the viscosity reached a target (approximately 2 hours) to prepare a binder solution. The binder solution was added to the dielectric slurry composition, and a dielectric ceramic sheet sample with a thickness of 0.8 μm or less was manufactured on a polyethylene terephthalate (PET) film using a doctor blade.

### EXPERIMENTAL EXAMPLE 1

FIG. 6 is a graph analyzing samples of dielectric slurry compositions with different types of dispersants using Fourier transform infrared spectroscopy.

Comparative Example 1-1 is a case in which dielectric particles including BaTiO₃ were added and a dispersant was not added, Comparative Example 1-2 is a case in which dielectric particles including BaTiO₃ were added and polyvinyl butyral (PVB) was used as a dispersant, and Example 1-3 is a case in which dielectric particles including BaTiO₃ were added and polyvinylpyrrolidone was used as a dispersant.

Referring to FIG. 6, it can be seen that Comparative Example 1-2 has peaks in a wavenumber region (a) corresponding to an acetal group of PVB and a wavenumber region (c) corresponding to a methylene group (—CH2), and Example 1-3 have a strong peak in a wavenumber region (b) corresponding to a carbonyl group (C═0).

### EXPERIMENTAL EXAMPLE 2

FIG. 7 is a graph comparing dispersion stability and viscosity of samples of dielectric slurry compositions with PVB as a dispersant and samples of dielectric slurry compositions with PVP dispersants with different molecular weights.

FIG. 8 is a graph comparing a particle size distribution of samples of dielectric slurry compositions with PVB as a dispersant and samples of dielectric slurry compositions with PVP dispersants with different molecular weights.

The characteristics of each Comparative Example and Example in FIGS. 7 and 8 are as follows, and the solubility parameter Ra of the dispersant in the ethanol-toluene solvent is 14. Dispersion stability was measured by instability index using disk centrifugation photosedimentometer (DCP; DC24000 UHR, CPS Instruments, USA) and LUMiSizer (LUM GmbH, Germany) at a rotation speed of 4000 RPM and a measurement temperature of 25° C., and viscosity was measured using a micro sample volume viscometer (m-VROC, Rheosense Inc., USA) at a measurement temperature of 25° C.

(1) Comparative Example 2-1: Dielectric particles including BaTiO₃ were added and polyvinyl butyral (PVB) was used as a dispersant

(2) Example 2-4: Dielectric particles including BaTiO₃ were added, polyvinylpyrrolidone was as a dispersant, and the molecular weight of the polyvinylpyrrolidone dispersant was 6320 g/mol

(3) Example 2-5: Dielectric particles including BaTiO₃ were added, using polyvinylpyrrolidone was used as a dispersant, and the molecular weight of the polyvinylpyrrolidone dispersant was 17700 g/mol

(4) Example 2-6: Dielectric particles including BaTiO₃ were added, polyvinylpyrrolidone was used as a dispersant, and the molecular weight of the polyvinylpyrrolidone dispersant was 27000 g/mol

(5) Example 2-7: Dielectric particles including BaTiO₃ were added, polyvinylpyrrolidone was used as a dispersant, and the molecular weight of the polyvinylpyrrolidone dispersant was 34100 g/mol

(6) Example 2-8: Dielectric particles including BaTiO₃ were added, polyvinylpyrrolidone was used as a dispersant, and the molecular weight of the polyvinylpyrrolidone dispersant was 309000 g/mol

Referring to FIG. 7, it can be seen that Comparative Example 2-1 has the instability index of 1.075 and Examples 2-4, 2-5, 2-6, 2-7, and 2-8 have the instability index of 0.168 or less. Meanwhile, the viscosity in all Comparative Examples and Examples except for Example 2-8 is at the level of 1.7 to 1.8 mPa·s, and it can be seen that, in the case that the effect of improving dispersion stability due to viscosity is excluded, the effect of improving dispersion stability is superior in the case that polyvinylpyrrolidone is used as a dispersant than in the case that polyvinyl butyral (PVB) is used as a dispersant.

Meanwhile, referring to FIG. 8, in the case of Example 2-4 compared to Comparative Example 2-1, D50 of the dielectric particles of the dielectric slurry composition decreased by about 2.5 nm, but in the case of Example 2-6 with a high molecular weight, it can be seen that, the thickness of the dispersant layer disposed on the surface of the dielectric particles becomes thicker, and as a result, the D50 value is at the same level as that of Comparative Example 2-1.

### EXPERIMENTAL EXAMPLE 3

FIG. 9 is a graph analyzing samples of dielectric slurry compositions with PVB as a binder and samples of dielectric slurry compositions with PVB binders and PVP dispersants with different molecular weights using Fourier transform infrared spectroscopy.

FIG. 10 is a graph illustrating stress-strain curves of samples of dielectric ceramic sheets with different types of dispersants.

In FIGS. 9 and 10, the characteristics of each Comparative Example and Example are as follows, and the solubility parameter Ra of the dispersant in ethanol-toluene solvent is 14.

In addition, each Comparative Example and Example included dielectric particles including BaTiO₃ and used polyvinyl butyral (PVB) as a binder.

To remove excess dispersant from the dielectric slurry composition for Fourier transform infrared spectroscopy analysis according to FIG. 9, a process of settling the dielectric particles using a centrifuge (10,000 rpm, 10 min) and then re-dispersing with EtOH was performed a total of three times. Thereafter, the dielectric particles were completely dried to remove any solvent remaining in the particles, and measurements were performed using a light source with a Beam Size of 70 μm (Depth: 3 to 5 μm).

In order to analyze tensile strength of the dielectric ceramic sheet using the dynamic mechanical analyzers (DMA) according to FIG. 10, each dispersant was mixed with a binder solution at the same ratio and applied to a PET film to produce a sheet. For the DMA measurement, strain and stress were measured, and a dumbbell-shaped specimen was cut from the dielectric sheet in a casting direction using a sample cutter. A tensile test was performed at a rate of 0.1 mm/s, and at least 4 samples were tested to calculate average tensile properties of these sheets.

(1) Comparative Example 3-1: No dispersant used.

(2) Example 3-1: Polyvinyl butyral was used as a dispersant.

(3) Example 3-2: Polyvinylpyrrolidone dispersant with a molecular weight of 6320 g/mol was used.

(4) Example 3-3: Polyvinylpyrrolidone dispersant with a molecular weight of 27,000 g/mol was used.

Referring to FIG. 9, as the molecular weight of the polyvinylpyrrolidone dispersant increases, the peak in the range of 3,100 cm⁻¹ to 3,700 cm⁻¹ corresponding to the hydroxyl group (—OH) of the binder shifts to a lower wavenumber, confirming that the interaction between the dispersant and the binder increases as the molecular weight of the polyvinylpyrrolidone dispersant increases.

Referring to FIG. 10, it can be seen that, yield strength of the dielectric ceramic sheet is higher in the case that polyvinylpyrrolidone dispersant is used than in the case that no dispersant is used or in the case that polyvinyl butyral is used as a dispersant and it can be seen that the yield strength of the dielectric ceramic sheet tends to improve as the molecular weight of the polyvinylpyrrolidone dispersant increases.

### EXPERIMENTAL EXAMPLE 4

FIG. 11A is a graph illustrating short rates of multilayer electronic components including dielectric layers with different types of dispersants, and FIG. 11B is a graph illustrating breakdown voltage (BDV) distributions of multilayer electronic components including dielectric layers with different types of dispersants.

The characteristics of Comparative Example and Example are as follows. A multilayer electronic component was manufactured by printing an internal electrode paste on a dielectric ceramic sheet, stacking individual sheets to produce a multilayer sheet, sintering the produced multilayer sheet at a temperature for implementing the same electrostatic capacity, and forming an external electrode through a termination process.

The short rate was measured in the case that a short circuit occurred by applying 500 mV at 120 Hz to a total of 30 samples of the multilayer electronic component, and as a dielectric breakdown voltage (BDV), a voltage applied from 0 V to chip destruction at a voltage increase rate of 50 V/sec was measured by using an HV BDV tester (PR12PF).

(1) Comparative Example 4-1: A multilayer electronic component was manufactured using a dielectric slurry composition including dielectric particles including BaTiO₃ and using polyvinyl butyral as a dispersant.

(2) Example 4-1: A multilayer electronic component was manufactured using a dielectric slurry composition including dielectric particles including BaTiO₃ and using polyvinylpyrrolidone (PVP) as a dispersant with a molecular weight of 27,000 g/mol.

### EXPERIMENTAL EXAMPLE 5

Table 1 below illustrates peeling force and static electricity of each dispersant occurring during peeling by types of plasticizer.

The peeling force and static electricity were measured using a peeling force measuring device (90° peel test) and a static electricity measuring device at a measurement temperature of 25° C. and a peeling rate of 300 mm/min after forming a dielectric ceramic sheet on a substrate by type of dispersant and plasticizer according to the classification below.

Dioctyl adipate (DOA) was used as a positively (+)-charged plasticizer, and tetraglyme was used as a negatively (−) charged plasticizer.

TABLE 1

| | | Peeling force | Static |
|---|---|---|---|
| classification | plasticizer | (N · m) | electricity (kV) |
| PVB dispersant | plasticizer A | 12.3 | 20.6 |
| PVP dispersant | (+ charge) | 13.7 | 29.3 |
| PVB dispersant | plasticizer B | 16.5 | −6.2 |
| PVP dispersant | (− charge) | 4.5 | 0.8 |

Referring to Table 1, it can be seen that, in the case that the plasticizer applied to the dielectric ceramic sheet assumes a negative charge (−), the absolute size of static electricity occurring during peeling is reduced in the case that the PVP dispersant is used, compared to in the case that the PVB dispersant is used, thereby reducing defects occurring during stacking.

### EXPERIMENTAL EXAMPLE 6

Table 2 below illustrates dispersibility of the dielectric slurry composition by molecular weight of the PVP dispersant and the mechanical properties of the dielectric ceramic sheet.

TABLE 2

| | | | | Evaluation of |
|---|---|---|---|---|
| | Molecular | | | mechanical |
| Type of | weight (x10³ | State of | Instability | properties of |
| dispersant | g/mol) | slurry | Index | sheets |
| PVP1 | 2.82 | aggregate | NG | NG |
| PVP2 | 5.18 | aggregate | NG | NG |
| PVP3 | 6.30 | normal | — | NG |
| PVP4 | 6.32 | normal | 0.168 | NG |
| PVP5 | 17.7 | normal | 0.167 | OK |
| PVP6 | 27.0 | normal | 0.110 | OK |
| PVP7 | 34.1 | normal | 0.102 | OK |
| PVP8 | 309 | High viscosity | 0.036 | NG |
| | | (>3 mPa · s) | | |
| PVP9 | 436 | aggregate | NG | NG |

Referring to Table 2, it can be seen that, in the case that the molecular weight of the PVP dispersant is 6300 g/mol or more and 309000 g/mol or less, no agglomeration occurs in the dielectric slurry composition. Meanwhile, it can be seen that, in the case that the molecular weight of the PVP dispersant is 63200 g/mol or more and 309000 g/mol or less, no agglomeration occurs in the entire slurry composition, and since instability index value is 0.168 or less, the dispersion stability is excellent. Meanwhile, it can be seen that, in the case that the molecular weight of the PVP dispersant is 17700 g/mol or more and 34100 g/mol or less, the mechanical properties of the dielectric ceramic sheet are improved. Meanwhile, in Table 2, the cases in which the instability index value exceeds 1.7 are indicated as NG, and mechanical property evaluation is evaluated as OK in the case that the elastic modulus is 15 MPa or more and the strain value is 10% or more, and NG in other cases.

### Multilayer Electronic Component

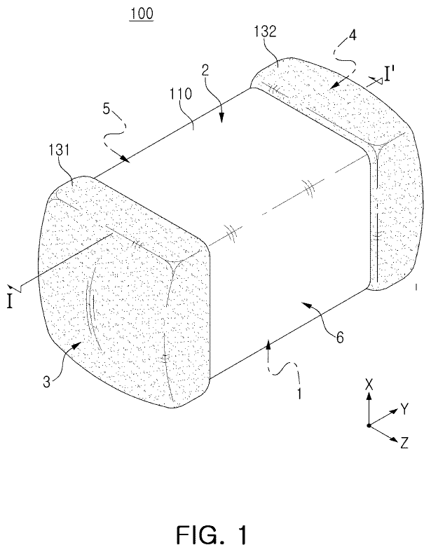

FIG. 1 is a perspective view schematically illustrating a multilayer electronic component.

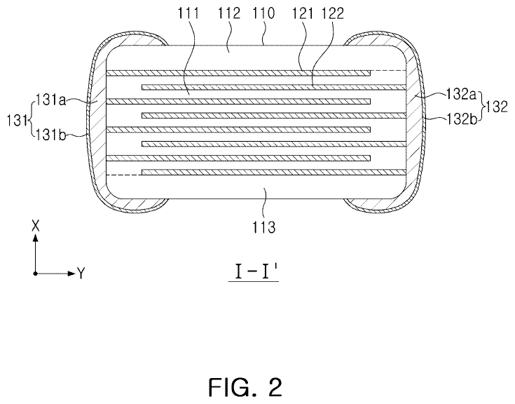

FIG. 2 is a cross-sectional view taken along line I-I′ of FIG. 1.

Hereinafter, a multilayer electronic component manufactured by a method for manufacturing a multilayer electronic component according to an embodiment of the present disclosure will be described in detail with reference to FIGS. 1 and 2. However, a multilayer ceramic capacitor will be described as an example of a multilayer electronic component, but the present disclosure may also be applied to various electronic products using a dielectric composition, such as an inductor, a piezoelectric device, a varistor, or a thermistor.

A body 110 includes dielectric layers 111 and internal electrodes 121 and 122 which are alternately stacked.

More specifically, the body 110 may include a capacitance forming portion including a first internal electrode 121 and a second internal electrode 122 arranged inside the body 110 and alternately arranged to face each other with the dielectric layer 111 therebetween to form capacitance.

There is no particular limitation on the specific shape of the body 110, but as illustrated, the body 110 may be formed in a hexahedral shape or a similar shape. Due to shrinkage of ceramic powder included in the body 110 during a sintering process, the body 110 may not have a perfect straight hexahedral shape, but may have a substantially hexahedral shape.

The body 110 may have first and second surfaces 1 and 2 opposing each other in the first direction, third and fourth surfaces 3 and 4 connected to the first and second surfaces 1 and 2 and opposing each other in the second direction, and fifth and sixth surfaces 5 and 6 connected to the first to fourth surfaces 1, 2, 3, and 4 and opposing each other in the third direction.

The plurality of dielectric layers 111 forming the body 110 are in a sintered state, and adjacent dielectric layers 111 may be integrated such that boundaries therebetween may not be readily apparent without using a scanning electron microscope (SEM).

The raw material forming the dielectric layer 111 is not limited as long as sufficient capacitance may be obtained. In general, perovskite (ABO₃)-based materials may be used, and, for example, barium titanate-based materials, lead composite perovskite-based materials, or strontium titanate-based materials may be used. The barium titanate-based materials may include BaTiO₃-based ceramic powder, and examples of ceramic powder include BaTiO₃ and Ba₁₋ₓCaₓ)TiO₃ (0<x<1), Ba(Ti_{1-y}Ca_{y})O₃ (0<y<1), (Ba₁₋ₓCaₓ)(Ti_{1-y}Zr_{y})O₃ (0<x<1, 0<y<1) or Ba(Ti_{1-y}Zr_{y})O₃ (0<y<1) in which Ca (calcium), Zr (zirconium), or the like is partially dissolved in BaTiO₃.

In addition, the raw material forming the dielectric layer 111 may be powder, such as barium titanate (BaTiO₃), to which various ceramic additives, organic solvents, binders, dispersants, etc. may be added according to the purpose of the present disclosure.

The internal electrodes 121 and 122 may be alternately stacked with the dielectric layer 111.

The internal electrodes 121 and 122 may include the first internal electrode 121 and the second internal electrode 122, and the first and second internal electrodes 121 and 122 may be alternately arranged to face each other with the dielectric layer 111 forming the body 110 interposed therebetween and may be exposed to the third and fourth surfaces 3 and 4 of the body 110, respectively.

More specifically, the first internal electrode 121 may be spaced apart from the fourth surface 4 and exposed through the third surface 3,
and the second internal electrode 122 may be spaced apart from the third surface 3 and exposed through the fourth surface 4. A first external electrode 131 may be disposed on the third surface 3 of the body 110 and connected to the first internal electrode 121, and a second external electrode 132 may be disposed on the fourth surface 4 of the body 110 and connected to the second internal electrode 122.

That is, the first internal electrode 121 may be connected to the first external electrode 131 without being connected to the second external electrode 132, and the second internal electrode 122 may be connected to the second external electrode 132 without being connected to the first external electrode 131. Here, the first and second internal electrodes 121 and 122 may be electrically separated from each other by the dielectric layer 111 disposed therebetween.

Meanwhile, the body 110 may be formed by alternately stacking a ceramic green sheet on which the first internal electrode 121 is printed and a ceramic green sheet on which the second internal electrode 122 is printed and then sintering the same.

The material forming the internal electrodes 121 and 122 is not particularly limited, and a material having excellent electrical conductivity may be used. For example, the internal electrodes 121 and 122 may include one or more of nickel (Ni), copper (Cu), palladium (Pd), silver (Ag), gold (Au), platinum (Pt), tin (Sn), tungsten (W), titanium (Ti), and alloys thereof.

In addition, the internal electrodes 121 and 122 may be formed by printing an internal electrode conductive paste including one or more of nickel (Ni), copper (Cu), palladium (Pd), silver (Ag), gold (Au), platinum (Pt), tin (Sn), tungsten (W), titanium (Ti) and alloys thereof on a ceramic green sheet. A printing method of the internal electrode conductive paste may include a screen-printing method or a gravure printing method, but the present disclosure is not limited thereto.

Meanwhile, the body 110 may include cover portions 112 and 113 arranged on both end-surfaces of the capacitance forming portion in the first direction.

More specifically, the body 110 may include an upper cover portion 112 disposed above the capacitance forming portion in the first direction and a lower cover portion 113 disposed below the capacitance forming portion in the first direction.

The upper cover portion 112 and the lower cover portion 113 may be formed by stacking a single dielectric layer 111 or two or more dielectric layers 111 on upper and lower surfaces of the capacitance forming portion in the first direction, respectively, and may basically play a role in preventing damage to the internal electrodes 121 and 122 due to physical or chemical stress.

The upper cover portion 112 and the lower cover portion 113 may not include the internal electrodes 121 and 122 and may include the same material as that of the dielectric layer 111. That is, the upper cover portion 112 and the lower cover portion 113 may include a ceramic material, for example, a barium titanate (BaTiO₃)-based ceramic material.

Meanwhile, a margin portion may be disposed on an end surface of the body 110 in the third direction.

More specifically, the margin portion may include a first margin portion arranged on the fifth surface 5 of the body 110 and a second margin portion arranged on the sixth surface 6. That is, the margin portion may be arranged on the end surfaces of the body 110 in the third direction.

The margin portion may refer to a region between both ends of the first and second internal electrodes 121 and 122 in the third direction and a boundary surface of the body 110 based on a cross-sections of the body 110 in the second and third directions.

The margin portion may basically play a role in preventing damage to the internal electrodes 121 and 122 due to physical or chemical stress.

The margin portion may be formed by applying a conductive paste to the ceramic green sheet, except for a region in which the margin portion is to be formed, to form the internal electrodes 121 and 122, perform cutting so that the internal electrodes 121 and 122 after stacking are exposed to the fifth and sixth surfaces 5 and 6 of the body 110 to suppress a step caused by the internal electrodes 121 and 122, and then stacking a single dielectric layer 111 or two or more dielectric layers 111 on both end surfaces of the capacitance forming portion in the third direction.

In an embodiment of the present disclosure, the ceramic electronic component 100 is described as having a structure including two external electrodes 131 and 132, but the number or shape of the external electrodes 131 and 132 may be changed depending on the shape of the internal electrodes 121 and 122 or other purposes.

The external electrodes 131 and 132 may be arranged on the body 110 and connected to the internal electrodes 121 and 122.

More specifically, the external electrodes 131 and 132 may include the first and second external electrodes 131 and 132 arranged on the third and fourth surfaces 3 and 4 of the body 110 and connected to the first and second internal electrodes 121 and 122, respectively. That is, the first external electrode 131 may be disposed on the third surface 3 of the body and connected to the first internal electrode 121, and the second external electrode 132 may be disposed on the fourth surface 4 of the body and connected to the second internal electrode 122.

The external electrodes 131 and 132 may be formed using any material having electrical conductivity, such as metal, and a specific material may be determined by considering electrical characteristics, structural stability, etc., and further, the external electrodes 131 and 132 may have a multilayer structure.

For example, the external electrodes 131 and 132 may include electrode layers 131a and 132a disposed on the body 110 and plating layers 131b and 132b disposed on the electrode layers 131a and 132a.

For a more specific example of the electrode layers 131a and 132a, the electrode layers 131a and 132a may be sintered electrodes including a conductive metal and glass or resin-based electrodes including a conductive metal and resin.

In addition, the electrode layers 131a and 132a may be in the form in which a sintered electrode and a resin-based electrode are sequentially formed on the body 110.

In addition, the electrode layers 131a and 132a may be formed by transferring a sheet including a conductive metal onto the body 110 or may be formed by transferring a sheet including a conductive metal onto a sintered electrode.

The conductive metal used in the electrode layers 131a and 132a is not particularly limited as long as it is a material that may be electrically connected to the internal electrodes 121 and 122 to form capacitance and may include, for example, one or more selected from the group consisting of nickel (Ni), copper (Cu), palladium (Pd), silver (Ag), gold (Au), platinum (Pt), tin (Sn), tungsten (W), titanium (Ti), and alloys thereof. The electrode layers 131a and 132a may be formed by applying a conductive paste prepared by adding glass frit to the conductive metal powder and then sintering.

The plating layers 131b and 132b play a role in improving the mounting characteristics.

The type of plating layers 131b and 132b is not particularly limited and may be single plating layers 131b and 132b including at least one of nickel (Ni), tin (Sn), palladium (Pd), and alloys thereof or may include multiple layers.

For more specific examples of the plating layers 131b and 132b, the plating layers 131b and 132b may be a Ni plating layer or a Sn plating layer and may be in a form in which a Ni plating layer and a Sn plating layer are sequentially formed on the electrode layers 131a and 132a or may be in a form in which a Sn plating layer, a Ni plating layer, and a Sn plating layer are sequentially formed. In addition, the plating layers 131b and 132b may include a plurality of Ni plating layers and/or a plurality of Sn plating layers.

One of the various effects of the present disclosure is to provide a dielectric slurry composition with improved dispersibility of dielectric particles.

One of the various effects of the present disclosure is to improve the mechanical strength of the dielectric ceramic sheet.

Although the embodiments of the present disclosure have been described in detail above, the present disclosure is not limited to the embodiments described above and the accompanying drawings, but is intended to be limited by the appended claims. Accordingly, various forms of substitution, modification, and change may be made by those skilled in the art within the scope without departing from the technical idea of the present disclosure described in the claims, and this will also be considered to fall within the scope of the present disclosure.

The expression “an exemplary embodiment or one example” used in the present disclosure does not refer to identical examples and is provided to stress different unique features between each of the examples. However, examples provided in the following description are not excluded from being associated with features of other examples and implemented thereafter. For example, even if matters described in a specific example are not described in a different example thereto, the matters may be understood as being related to the other example, unless otherwise mentioned in descriptions thereof.

The terms used herein are for the purpose of describing particular embodiments only and are not intended to limit the example embodiments. As used herein, the singular forms “a,” “an” and “the” are intended to include the plural forms as well, unless the context clearly indicates otherwise.

What is claimed is:

1. A dielectric slurry composition comprising:
a dielectric particle including BaTiO₃,
a solvent including ethanol and toluene,
a dispersant including polyvinylpyrrolidone, and
a binder,
wherein a mass ratio of ethanol to toluene is greater than 1.0 and less than 2.3.

2. The dielectric slurry composition of claim 1, wherein a molecular weight of polyvinylpyrrolidone is 6300 g/mol or more and 309000 g/mol or less.

3. The dielectric slurry composition of claim 1, wherein a Hansen solubility parameter of the dispersant is greater than 13 and less than 16.

4. The dielectric slurry composition of claim 1, wherein the dispersant is disposed on a surface of the dielectric particle.

5. The dielectric slurry composition of claim 1, wherein the polyvinylpyrrolidone comprises a nitrogen (N) element that is disposed on a surface of the dielectric particle.

6. The dielectric slurry composition of claim 1, wherein the binder includes polyvinyl butyral.

7. The dielectric slurry composition of claim 6, wherein, a number of repeating units in polyvinylpyrrolidone is n, and a number of repeating units comprising a hydroxyl group included in polyvinyl butyral is y, n/y satisfies 0.67 or more and less than 3.7.

8. A dielectric ceramic sheet comprising:
a dielectric particle including BaTiO₃,
a dispersant including polyvinylpyrrolidone,
a binder, and
a plasticizer,
wherein the plasticizer has a negative charge.

9. The dielectric ceramic sheet of claim 8, wherein the plasticizer includes at least one selected from triglyme, tetraglyme, and polyglyme.

10. The dielectric ceramic sheet of claim 8, wherein a molecular weight of polyvinylpyrrolidone is 6300 g/mol or more and 309000 g/mol or less.

11. The dielectric ceramic sheet of claim 8, wherein the dispersant is disposed on a surface of the dielectric particle.

12. The dielectric ceramic sheet of claim 8, wherein the polyvinylpyrrolidone comprises a nitrogen (N) element that is disposed on a surface of the dielectric particle.

13. The dielectric ceramic sheet of claim 8, wherein the binder includes polyvinyl butyral.

14. The dielectric ceramic sheet of claim 13, wherein, a number of repeating units in polyvinylpyrrolidone is n, and a number of repeating units comprising a hydroxyl group included in polyvinyl butyral is y, n/y satisfies 0.67 or more and less than 3.7.

15. The dielectric ceramic sheet of claim 8, wherein the plasticizer includes tetraglyme.

16. The dielectric ceramic sheet of claim 8, wherein the plasticizer is free of dioctyl adipate.

17. A method of manufacturing a multilayer electronic component comprising:
forming a body of the multilayer electronic component from the dielectric ceramic sheet of claim 8.
